(19) United States
(12) Patent Application Publication
(10) Pub. No.: US 2014/0143005 A1
(43) Pub. Date: May 22, 2014

(54) PLM IN A BOX is a proprietary Process in the development and implementation a Product Lifecycle Management Solution for product manufacturers developing products based on a customer specification. This process establishes a process framework to linking customer project to a product design originated for a specific customer project, links to the design exchanges with suppliers on those designs and the linkage engineering change notices that originate for those product designs

(71) Applicant: Hemant B. Jatla, Crescent Springs, KY (US)

(72) Inventor: Hemant B. Jatla, Crescent Springs, KY (US)

(21) Appl. No.: 13/344,601

(22) Filed: Mar. 13, 2012

(51) Int. Cl. G06Q 10/06

(52) U.S. Cl. CPC G06Q 10/06313
USPC 705/7.23

(57) ABSTRACT

PLM IN A BOX is a proprietary Process in the development and implementation a Product Lifecycle Management Solution for product manufacturers developing products based on a customer specification. This process establishes a process framework to linking customer project to a product design originated for a specific customer project, links to the design exchanges with suppliers on those designs and the linkage engineering change notices that originate for those product designs.

FIG. 0 illustrates the core theme of the business problem solved by this invention. Lack of a central interconnected PLM system inhibits an organization's ability to quickly understand impact of a change and coordinate the change activities in an efficient manner. This problem is compounded with increased customers, suppliers, product complexity, product volume, etc.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to Product Lifecycle Management (PLM). Particularly, the present invention relates to enabling product development organization to assess the impact of a design change to the related design projects, product customers, and suppliers. PLM-IN-A-BOX (PIAB) forms a process apparatus that connects the data collected from these process activities so as to enable quick decision making that result in efficiencies within product development.

### DISCUSSION OF THE BACKGROUND

This patent discloses a method for linking product design and development processes including configuring application objects embodied in a computer program. The inventor recognized that the patent does not provide any solution to synchronize key supply chain modules (ERP, SCM, and APS etc.) and production support systems (LIMS and FCS etc.) with events and activities that occur on the factory floor.

### SUMMARY OF THE INVENTION

A PLM system means a software application that manages the entire lifecycle of a product from its conception, through design and manufacture, to service and disposal. The resulting values provided by PLM are data that can be automatically converted into “actionable information” that can then be used for improved decision making at all levels of product development. For example, PLM provides values derived from data obtained from engineering, quality, project management, etc.

PIAB is a holistic integration of the following product development processes within an organization:
a. Customer Project Activities
b. Product Design verification and validation
c. Secured Supplier Design Exchange
d. Engineering Change Management (Change Request, Change Notice, Change Implementation, Deviations, Corrective Actions, Audits, and Inspections)
e. First Article Inspection/Production Part Approval
f. Release to Production (PLM to ERP)

PLM Software Application Vendors offer point solutions to the above processes without a comprehensive framework that connects the activity level relationships across product development processes. Lack of a comprehensive view to these processes results missed opportunities to improve efficiencies across the product development organization.

PIAB solution is about the information, and how to establish the relationships amongst various process activities such as: customer collaboration, supplier collaboration, project design execution, product design verification, product design validation, product design change, production part approval, assets maintenance and employee job training record. The relationship across activities within these processes turn that data into information that can be used by managers at all levels of the enterprise to make mission-critical decisions. To summarize, PIAB is about empowering product development organization to make decisive judgments at speed along with optimizing the flow of information across product development organization, customers and suppliers.

### BRIEF DESCRIPTION OF THE DRAWINGS

FIG. 0 illustrates the core theme of the business problem solved by this invention.

FIG. 1 illustrates a commercial embodiment of a PIAB process of this invention.

FIG. 2 illustrates the Design Project Execution Process.

FIG. 3 illustrates the Design Package Verification Process.

FIG. 4 illustrates the setup of suppliers to access the shared designs.

FIG. 5 illustrates the supplier design exchange process.

FIG. 6 illustrates customer verification process.

FIG. 7 illustrates design validation process.

FIG. 8 illustrates customer validation process.

FIG. 9 illustrates Release to Production process.

FIG. 10 illustrates Engineering Change Management processes.

FIG. 11 illustrates First Part Approval Process.

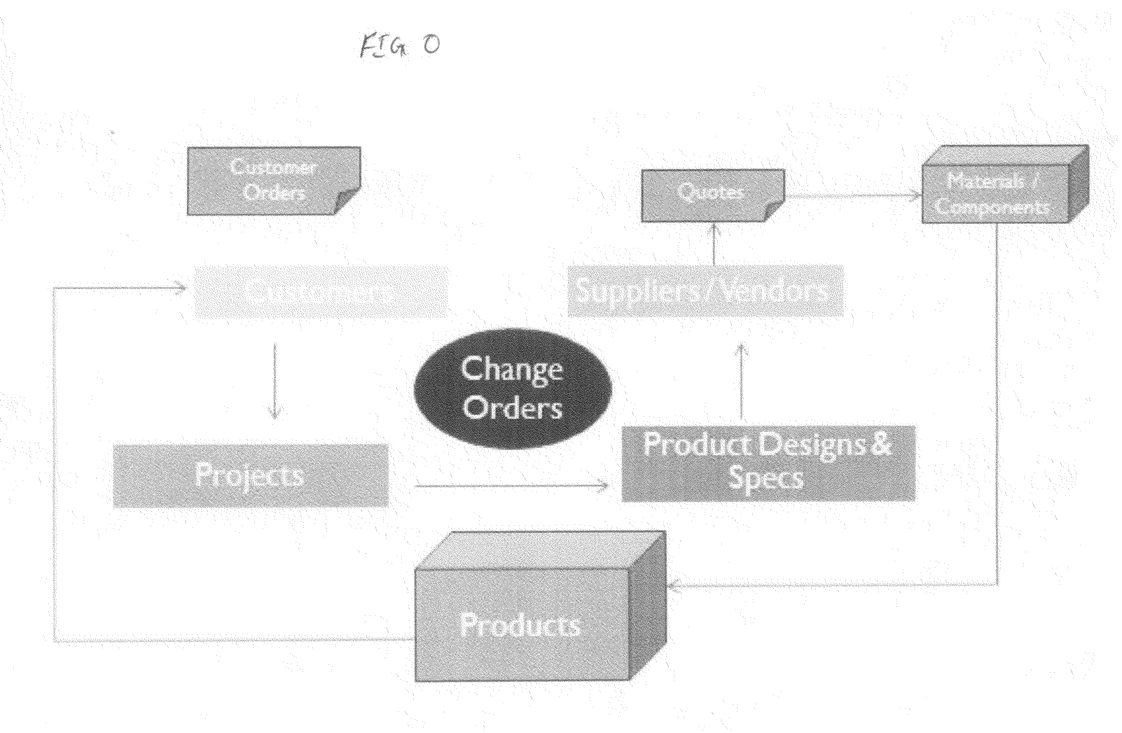

### DETAILED DESCRIPTION OF THE INVENTION

FIG. 1 illustrates a commercial embodiment of a PIAB process of this invention.

Product Development Process starts with a product development project namely “Project Activities” for a given customer proposal. Project folders, access, team and schedule is setup, design requirements and specifications are loaded into project. The project is setup per a preconfigured template that consists of the following phases:
Design Inputs
Design Outputs
Design Review
Verification
Validation
Preproduction
Validation
Production Released

### PROJECT DESIGN EXECUTION

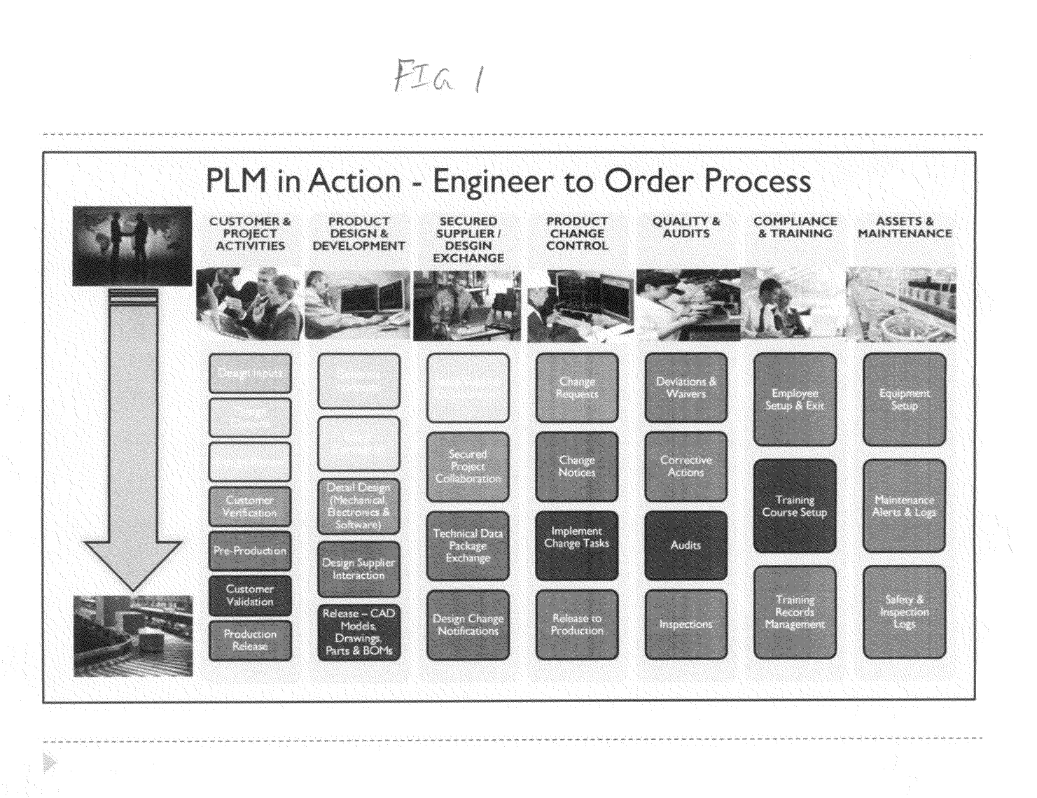

FIG. 2, illustrates the Design Project Execution that consists of the above projects phases and the detailed project activities within each of the project phases. After a customer approves the contract, customer inputs are loaded into the project. These inputs can range from simple sketches to documented design requirements and to complex mathematical and or computer aided design (CAD) models.

Theoretical design outputs are generated for the project, internal reviews are conducted, cost estimates are generated, and if required, proposal is delivered to the customer for acceptance. If customer approves the proposal, design teams begin their detailed design activities namely “Design Package Verification and Validation”.

### DESIGN VERIFICATION PROCESS

FIG. 3, illustrates the design verification process. During the design verification process, design teams create a package of design specifications and conduct internal reviews. While developing detailed designs, product development team's source for the suitable suppliers that can provide components and or subsystems at the best cost that meet the specifications set forth by the customer. Sourcing activities begin with creating Supplier Packages namely “Secured Supplier/Vendor Collaboration” which contain design specifications and preliminary 3 Dimensional (3D) and or 2 Dimensional (2D) Computer Aided Design CAD documents and other design specifications.

### SUPPLIER/VENDOR DESIGN EXCHANGE PROCESS—SUPPLIER/VENDOR PROJECT SHARING

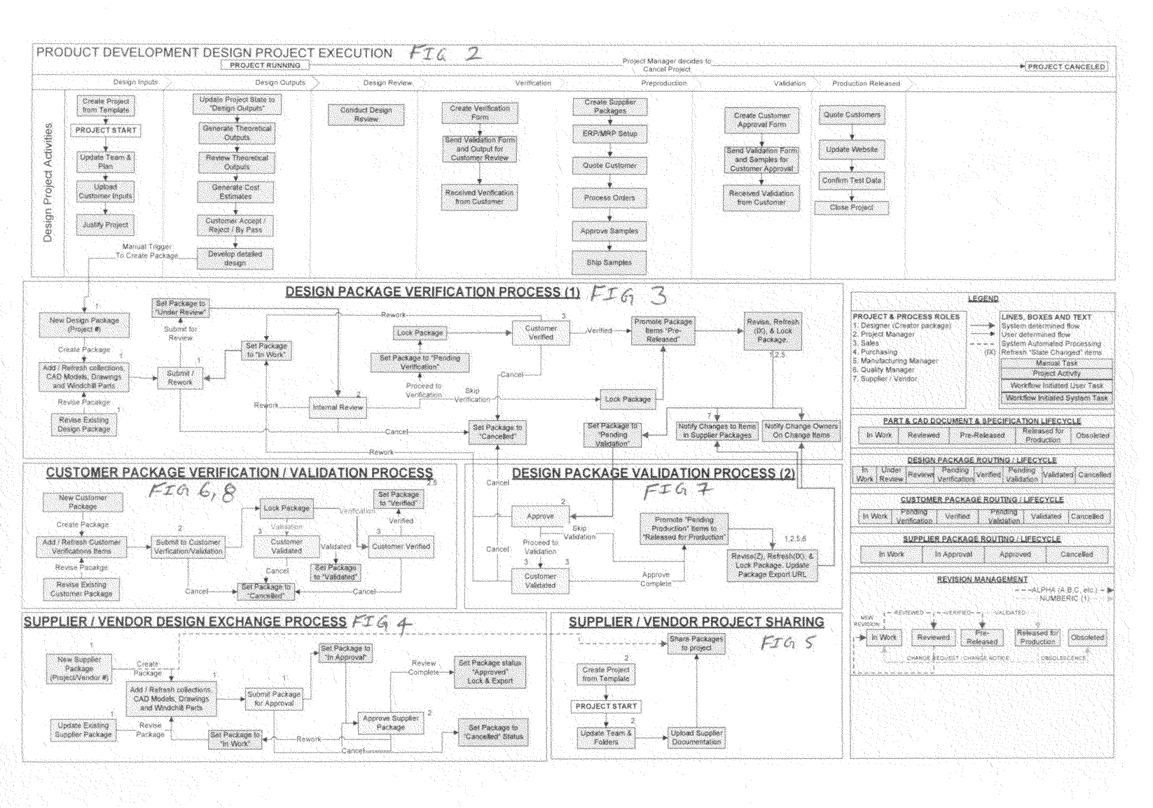

FIG. 4, illustrates the setup of suppliers to access the shared designs. FIG. 5, illustrates the supplier design exchange process by which designs are securely shared to suppliers or vendors or external design partners. Suppliers receive these delivery packages and in response provide samples and or their version of the detailed designs for review. Design engineers incorporate the supplier component or subsystem design version into the overall product design and conduct internal reviews and design verifications.

As indicated in the figure after “Review Complete”, a verification results are packaged and submitted for customer approvals. If customer verification is not required, Designs move to “Pre-Released” state, and Design Package moves to “Reviewed” state. If the designs require customer verification, Designs move to “Reviewed” state, and Design Package moves to “Pending Verification” state.

### CUSTOMER VERIFICATION PROCESS

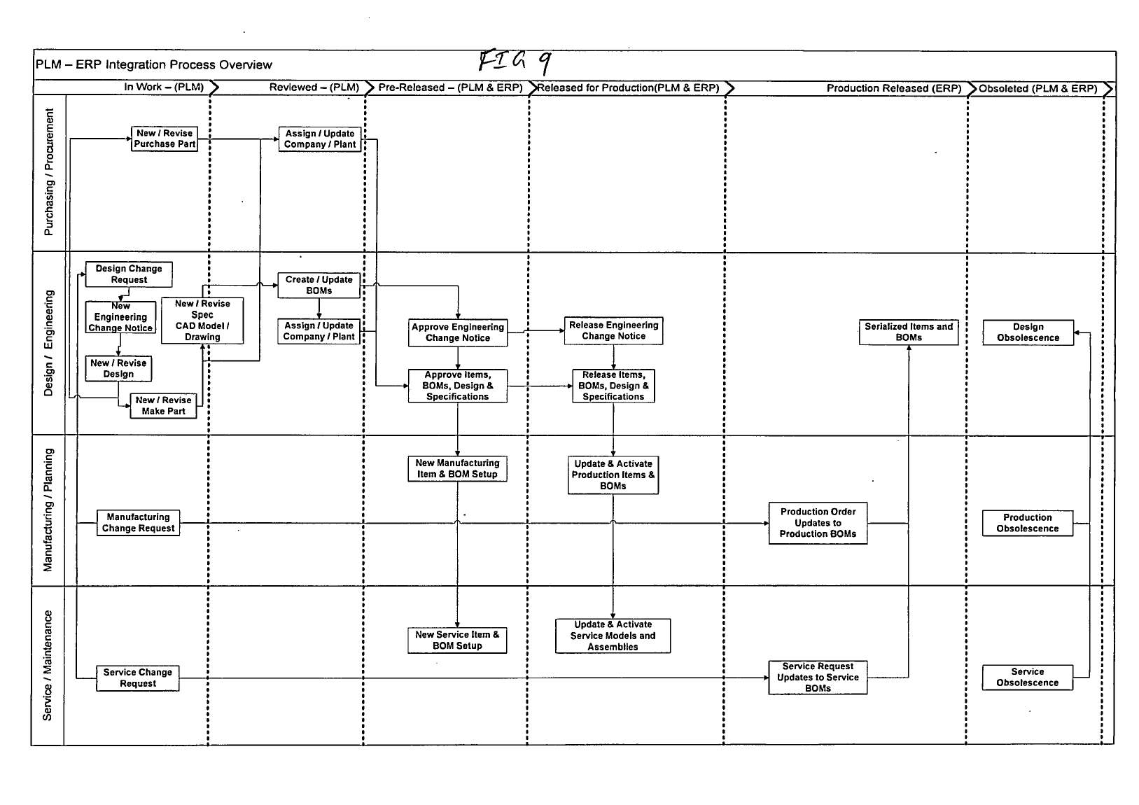

FIG. 6, illustrates customer verification process. If customer verification is required, a customer package is created which consists of design outputs, test plans, design specifications, virtual prototypes or design simulations, and customer verification approval forms. Subsequent to the customer approval of the verification plan, Design Package moves to “Verified” state.

Project engineering manager or sales or a customer liaison obtains the verification approval from the customer. If customer asks requests for changes, designs are reworked and go thru the design package verification process, and customer verification process cycle is repeated. If customer approves, Designs move to designs move into a “Pre-Released” state, and Design Package moves to “Verified” state.

The design goes several design iterations and approvals before it is finalized for customer validation. During these design iterations, design teams interact with suppliers using supplier packages and design changes are received and incorporated into the final design before it's approved.

### DESIGN VALIDATION PROCESS

FIG. 7, illustrates design validation process. The final validation process starts with integration, build and testing of sample physical parts and assemblies which could also consist of parts from their Suppliers. After several successful test cycles, samples will be ready for delivery to the customer for further testing and validation by integrating into customer's final assemblies.

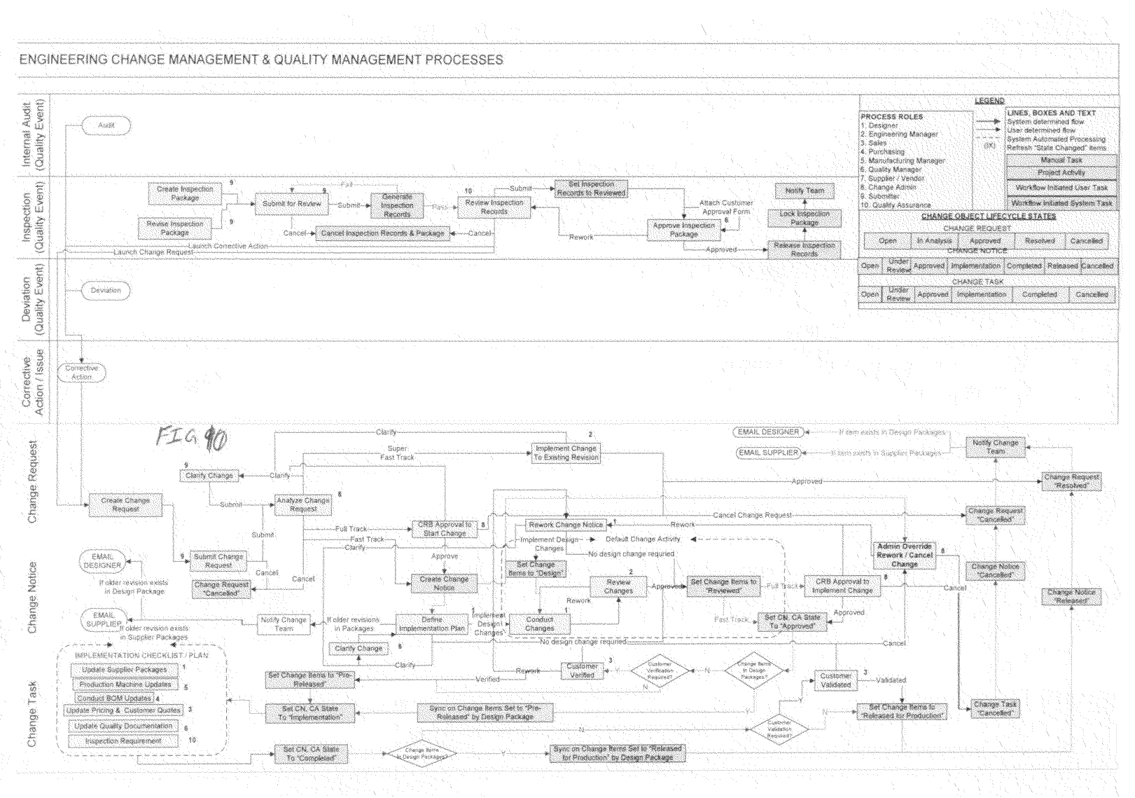

During the build and test cycles, quality events such as: internal audits, deviations to production processes, inspections on supplier and prototype parts, and corrective actions could lead to engineering change requests. Due to distinct product development process rigor established during the project execution, design verification, customer verification, supplier design exchange, and design validation, product engineering now has an instant capability to understand the impact of a change to a design across projects, customers and suppliers. FIG. 8, illustrates Engineering Change Management processes. Engineering Change Management Process is explained at a greater detail in the subsequent sections.

If customer validation is not required, project leader approves the designs for release to production. Designs are moved to “Production Released” state, and Design Package moves to “Validated” state. If the designs require customer validation, Design Package moves to “Pending Validation” state.

### CUSTOMER VALIDATION PROCESS

FIG. 8, illustrates customer validation process. If customer validation is required, a customer package is created which consists of test plans, design specifications and other relevant design documentation and approval forms. Customer Package goes thru a customer validation process wherein samples are shipped to the customer. Project engineering manager or sales or a customer liaison obtains the validation approval from the customer. If customer asks requests for changes, designs are reworked and go thru the review process, and thus the customer verification cycle is repeated. If customer approves, Designs move to designs move into a “Production Released” state, and Design Package moves to “Validated” state.

### RELEASE TO PRODUCTION PROCESS

FIG. 9, illustrates Release to Production Process. After Customer Approval is complete, designs are ready for release to production for the actual production. Planning events are scheduled per the customer delivery cycle. If any of the designs have a pending change notice, such designs have to me be modified and finalized prior to their release.

### ENGINEERING CHANGE MANAGEMENT PROCESS

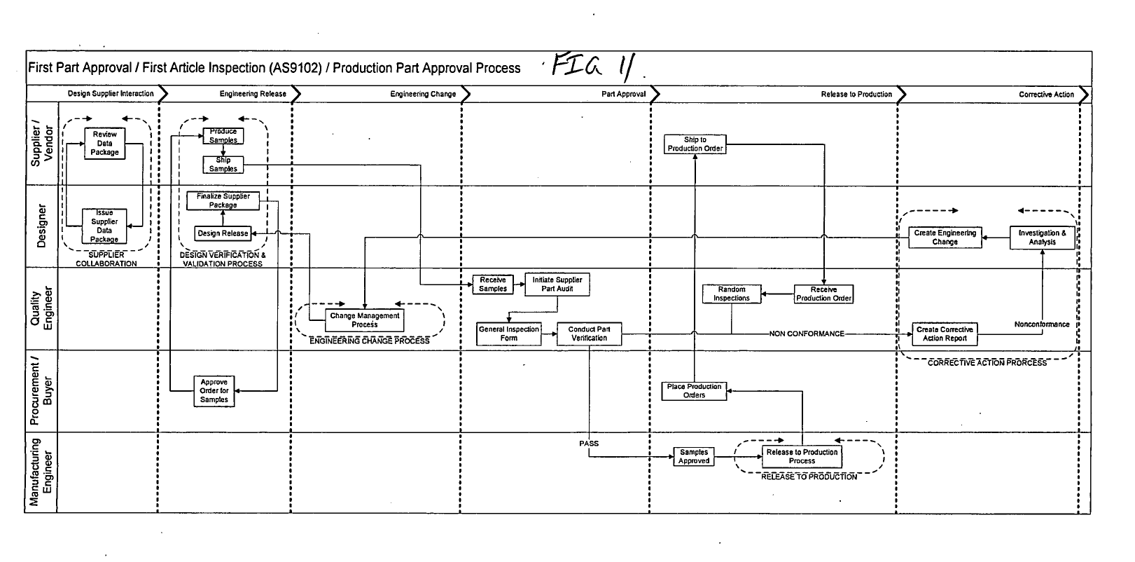

FIG. 10, illustrates Engineering Change Management processes. Change process begins with change analysis and thereafter disposition the change request to either a superfast track or full track or fast track change. Superfast track is used to make quick changes to existing revisions of designs. Fast track and full track goes thru a change notice and implementation plan. Full track goes thru an additional “Change Review Board (CRB) Approval” on both the Change Request and the Change Notice. The CRB consists of cross functional people from production, procurement, product engineering, project engineering, and quality. As a part of the implementation plan, design changes if raised by the customer are implemented and sent out for customer verifications and validations.

### FIRST PART APPROVAL/FIRST ARTICLE INSPECTION/PRODUCTION PART APPROVAL PROCESS

FIG. 11, First part Approval Process begins prior to completion of customer validation task, a production test run either at the plant location or from the supplier's production facility is inspected for quality and certified prior making volume runs or using expensive tooling equipment. If errors identified, corrective actions are raised which further trigger a change request and change notice to engineering design. If quality failure is a result of supplier part, a non-conformance is raised and communicated to suppliers. If design changes are involved, change request and change notice are raised to correct the issues. Following these changes, inspection cycle is repeated until quality requirements are met.

We claim:

1. A method for establishing a dependency from a design to its relevant project for a given customer, and the suppliers from whom either the design or the physical part is sourced from.

2. The method as claimed in claim 1, wherein has the ability to notify relevant product design project team members, customers and suppliers to ensure complete product change collaboration and notifications.

3. The method as claimed in claim 1, wherein has the ability to conduct customer verifications at the verification design stage and customer validation at the validation design stage.

4. The method as claimed in claim 1, wherein has the ability to prevent releases on new designs if there are pending design changes.

5. The method as claimed in claim 1, wherein has the ability to relate various design activities that occur thru the product development and design process. These activities include but not limited to: Design Package Verification, Design Package Validation, Customer Package Verification, Customer Package Validation, Supplier Design Exchange, Design Project Execution and Engineering Change Management.

6. A method to release engineering design specifications and bills of material to manufacturing.

7. The method as claimed in claim 6, wherein has the ability to release approved parts and bills of material to manufacturing systems using engineering change management and thus allowing for the setup of manufacturing and service items.

8. The method as claimed in claim 6, wherein has the ability to bring back serialized bills of materials from manufacturing systems into the PLM system thus allowing for a completed where-used lookup analysis on components and subassemblies that exist on their higher level assemblies.

9. The method as claimed in claim 6, wherein has the ability to trigger item obsolescence from PLM into manufacturing systems.

10. A method to link failed part inspections to suppliers, corrective actions, non-conformances, engineering changes and engineering releases.

11. The method as claimed in claim 10, wherein has the ability to link supplier audits to non-conformances

12. The method as claimed in claim 10, wherein has the ability to link non-conformances to corrective actions

13. The method as claimed in claim 10, wherein has the ability to link corrective actions to change investigations.

14. The method as claimed in claim 10, wherein has the ability to trigger engineering change as a result of investigation and change analysis.

15. The method as claimed in claim 10, wherein has the ability to notify suppliers on failed inspections that led to non-conformance.

16. The method as claimed in claim 10, wherein has the ability to force inspection on supplier parts and components have failed prior inspections.
